(19) United States
(12) Patent Application Publication
(10) Pub. No.: US 2024/0168979 A1
(43) Pub. Date: May 23, 2024

(54) HIERARCHICAL VISUALIZATION OF CLUSTERED DATASETS

(71) Applicant: ORACLE FINANCIAL SERVICES SOFTWARE LIMITED, Mumbai (IN)

(72) Inventors: Abhishek ANAND, Bokaro Steel City (IN); Shubham NEGI, Bilaspur (IN); Rahul YADAV, Behror (IN); Veresh JAIN, Bengaluru (IN)

(21) Appl. No.: 17/989,202

(22) Filed: Nov. 17, 2022

(51) Int. Cl. G06F 16/28; G06F 16/22

(52) U.S. Cl. CPC G06F 16/287; G06F 16/2246

(57) ABSTRACT

Systems, methods, and other embodiments associated with converting a static cluster data table to a graphical hierarchical tree are described. In one embodiment, a method includes recursively traversing the static cluster data table to identify a root cluster, identify child clusters from the root cluster and child clusters from each other that define parent-child relationships, and identify decision segments that caused a segment split of cluster data. A 2-dimensional visual hierarchy is generated and displayed in a graphical form using a plurality of nodes that represent the root cluster and the child clusters along with path lines that connect the nodes. The 2-dimensional visual hierarchy displays a hierarchical visualization of the static cluster data table that shows an order of decision segments that occurred to segment a dataset and how the dataset was segmented by a clustering algorithm leading to a final cluster of a leaf node.

A portion of the disclosure of this patent document contains material subject to copyright protection. The copyright owner has no objection to the facsimile reproduction of the patent document or the patent disclosure as it appears in the Patent and Trademark Office patent file or records, but otherwise reserves all copyright rights whatsoever.

### BACKGROUND

Clustering is a useful technique to segment entities based on their characteristics and past history. Clustering is an unsupervised approach to segment an input dataset and works as a black box. Thus, it becomes difficult for an end user to realize how the segmentation is performed by a clustering algorithm or determine what patterns the algorithm has learned and/or how segmented groups were created.

Clustering is widely used in modelling processes. Sometimes, it indirectly serves the non-clustering use cases by extracting features in a feature engineering phase. It groups similar entities, which enables an administrator to target the specific groups with relevant strategies. But since clustering is an unsupervised algorithm, it works as a black box and does not provide much, if any information, about the decisions taken by the clustering algorithm to segment a dataset into groups. As such, it is difficult for an end-user to know what patterns the algorithm/model has learned and how the clustered groups are created.

For example, when a dataset contains many dimensions (e.g., 100 features), the end-user will not be able to understand what considerations were made by the algorithm while segmenting the dataset. Generally, clustering outputs are plotted as a scatter plot to spot different clusters together. With the scatter plot and other similar representations, a person (end-user) can only visualize the final clustered outputs and that is comprehensible only when the number of features/dimensions is 2 or 3. The end-user cannot visually comprehend higher-dimensional data and certainly not a 100-dimensional scatter plot.

Furthermore, the use of machine learning (ML) clustering models to automate processes has increased. Companies are using ML algorithms to make predictions on their data such as predicting delinquent customers, detecting anomalies in bills, segmenting customers on their features, etc. ML algorithms are technical and the outputs they provide are difficult to comprehend for the end-user, who might not be acquainted with the intricacies of the ML algorithms and their output structures. It may be desirable for an improved data visualization for an easy-to-grasp representation of the ML model outputs or other clustering algorithm outputs.

### SUMMARY

In one embodiment, a computing system is described that includes a computer-implemented method that comprises converting a static cluster data table comprising cluster results of a dataset to a graphical hierarchical tree by:

Recursively traversing the static cluster data table to identify a root cluster, identify child clusters from the root cluster and child clusters from each other that define parent-child relationships, and identify decision segments that caused a segment split of cluster data at a parent cluster; and

Generating and displaying, on a display screen, a 2-dimensional visual hierarchy in graphical form using a plurality of nodes that represent the root cluster and the child clusters that are connected by path lines based on the parent-child relationships, wherein the 2-dimensional visual hierarchy displays a hierarchical visualization of the static data table that shows the parent-child relationships between each of the plurality of clusters and the decision segments from the static data table by the path lines between the plurality of nodes. The 2-dimensional visual hierarchy thus provides insights and explanations as to how a clustering algorithm (e.g., machine learning (ML) model) segmented the dataset into the clusters results of the dataset.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a visualization system for generated graphical hierarchical trees.

FIG. 2 illustrates a prior art example of a cluster output table.

FIG. 3A illustrates one embodiment of a graphical hierarchical tree that may be generated from the cluster results of the cluster output table from FIG. 2.

FIG. 3B illustrates one embodiment of the graphical hierarchical tree from FIG. 3A shown with more detail, but being shown as wrapped/folded in order to fit on one display page.

FIG. 4 illustrates an embodiment of a recursive algorithm that is associated with recognizing and identifying cluster information from a cluster output table.

FIG. 5 illustrates one embodiment of a method that is associated with converting a static cluster output table into a graphical hierarchical tree.

FIG. 6 illustrates another embodiment of the graphical hierarchical tree (from FIG. 3A, 3B) with interactive selection features for highlighting path links from a leaf node.

FIG. 7 illustrates another embodiment of the graphical hierarchical tree (from FIG. 3A, 3B) with interactive selection features for highlighting path links from a parent node.

FIG. 8 illustrates another embodiment with interactive selection features for displaying cluster information from a leaf node.

FIG. 9 illustrates another embodiment with interactive selection features for displaying cluster information and decision boundaries from a decision segment in the graphical hierarchical tree.

FIG. 10 illustrates an embodiment of a computing system configured with the example visualization systems and/or methods disclosed.

### DETAILED DESCRIPTION

Systems and methods are described herein that provide an intelligible visualization tool for clustering algorithms that output clustered datasets. In one embodiment, the present visualization tool generates a graphical hierarchical tree that converts a cluster output table into a 2-dimensional (2-D) visual hierarchy. The graphical hierarchical tree is a visual decision tree generated as an interactive visualization of the clustered dataset, which is an intuitive way to help humans make well-informed decisions about identified segments in the clustered dataset. The interactive visualization may be used for distribution analysis and provides path and segment separation details between nodes that represent a cluster/segment of data.

The graphical hierarchical tree provides a visualization of the clustered data that helps to observe relationships between segments and the segment boundaries of the clustered dataset that was used by the clustering algorithm to form the segments. The visualization converts static clustering decision tables generated by machine learning (ML) clustering models into visual descriptions of relevant features, decision boundaries considered while creating segments, and the order decisions were considered by the ML clustering model.

As such, the present system provides a data visualization that maps multiple dimensional data into a more intuitive visual representation. In one embodiment, the data visualization explicitly shows decisions taken at each node by the clustering algorithm to divide data into multiple segments. Human vision is more adaptive to data that is transformed into visualization.

In one embodiment, the present visualization tool solves the problems of prior clustering techniques by using a hierarchical approach to visualize the segments of a clustered dataset. For example, the present visualization tool plots the clustered dataset as a graphical visual decision tree including nodes of decision segments. This improves previous techniques by explicitly showing the decisions taken at each decision node that divides/segments the dataset into multiple clusters. Thus, the generated decision tree provides information about the decisions taken by the clustering algorithm, which was not previously available.

The present visualization tool also improves and solves the high-dimensionality problem of previous techniques because even for high dimensional datasets, the visual decision tree that is generated remains 2-dimensional. Accordingly, in one embodiment, the present visualization tool takes an output table of a clustered dataset from a clustering algorithm and plots the output table in a graphical visualization having a 2-dimensional hierarchical form that is easy to comprehend, regardless of how many dimensions the output table contains. Thus, the present graphical hierarchical tree works with hundreds of features/variables that may be part of the clustering results, which cannot be shown in typical trees, heat maps, or scatter plots.

### Definitions

A “cluster” as used herein refers to, but is not limited to, a group of data or data records from a dataset that have been grouped together based on a shared attribute/characteristic or having similar attributes/characteristics to each other. The group of data in a cluster is more related to each other based on one or more attributes/characteristics than to other clusters that may exist in the dataset. For example, attributes for clustering a customer dataset may include demographics, professions, income, credit score, behavior, and other values. A clustering algorithm such as a machine learning (ML) algorithm may be used to identify similarities in an input dataset to create cluster results.

A “segment” as used herein refers to, but is not limited to, a sub-set of data that has been divided or split from a larger dataset. A segment may also be regarded as a “cluster” of data, and these terms are sometimes used interchangeably. The conditions for segmenting a dataset are referred to as decision boundaries, which define a criterion for splitting a dataset into segments based on a defined value or condition of an attribute/characteristic of the data. For example, dividing a group of people based on whether a person's age is less than 18 or is 18 or older creates two segments of the data. The decision boundary in this example may be Age<18?: if true/yes, then move data record to segment #1; and if false/no, then move data record to segment #2. Segments may be further segmented into smaller sub-sets based on additional decision boundaries that may be applied, which then create different, smaller, and more similar clusters of data. A segment (or segmented cluster) that is not further divided is a final cluster of data.

### Overview

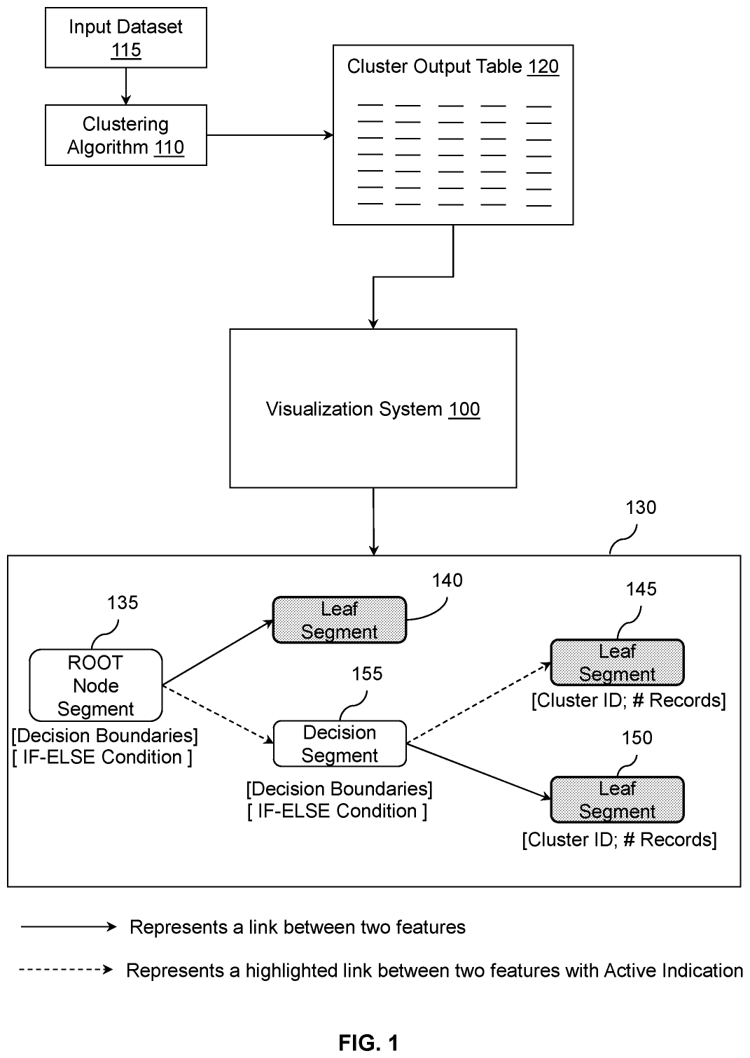

With reference to FIG. 1, one embodiment of a visualization system 100 is illustrated. The visualization system 100 is implemented in a computing device that is configured to perform the functions as described herein. As an overview, a clustering algorithm 110 takes an input dataset 115 and identifies patterns and generates an output of clustering results. In one embodiment, the clustering algorithm 110 may perform orthogonal partitioning clustering, but is not limited thereto. The output may be a cluster output table 120 that describes clusters of data and is typically in a static numeric format including columns and rows of information describing the clusters. The clustering algorithm 110 may or may not be part of the same computing system as the present visualization system 100. The specific details and implementation of the clustering algorithm is beyond the scope of this disclosure. The relevant portion is that the cluster output table 120 is used as input to the visualization system 100.

In one embodiment, the visualization system 100 is configured to convert the static cluster output table 120 of cluster results into a graphical hierarchical tree 130. A generic form of the graphical hierarchical tree 130 is shown in FIG. 1 to simplify the description with a small example of a graphical model. A more detailed explanation is provided below. The visualization system 100 generates and displays the graphical hierarchical tree 130 on a display screen as a 2-dimensional visual hierarchy using a plurality of nodes that starts with the root node/segment 135 and displays child nodes/segments connected with path lines based on parent-child relationships of clusters determined from the cluster output table 120.

In general, a segment-based split is generated and depicted in the data visualization of the graphical hierarchical tree 130, starting with the root node 135 and ending with a decision made by each segment (represented by a tree node). In one embodiment, the graphical hierarchical tree 130 generated by the visualization system 100 is a horizonal decision model. This means that the leftmost node is the root node 135, which is further broken down into several segments of data based on decision segments (e.g., decision segments 155).

Every decision segment is an IF-ELSE condition or other similar decision condition that can set decision boundaries for splitting the data into further segments. For example: If the decision condition 155 is true, the tree will expand horizontally to the right with the true condition segment of data at the top child node (e.g., leaf node 145), and ELSE the remaining data records move to the bottom child node (e.g., leaf node 150). This horizontal model allows for easy separation of content and minimizes confusion when visually understanding the graphical model of cluster results.

With continued reference to FIG. 1 and graphical hierarchical tree 130, the tree nodes may be understood as follows. The root node 135 represents a starting point with a decision segment that splits the initial input dataset 115 (e.g., the original data population) into two sub-segments based on a decision boundary. In other embodiments, three or more sub-segments may result from a decision segment based on the number of conditions in the decision segment. Each path in the hierarchy ends with a leaf node that represents a specific final cluster of data (e.g., leaf nodes 140, 145, and 150). Leaf nodes are not further segmented/divided and are therefore considered a resultant final segment/cluster.

Each leaf node may visually identify information about its associated cluster of data with a cluster identifier (ID) and a number of records or data points in the cluster, which are determined from the cluster output table 120. The cluster information of a node may also be displayed in response to a selection of the node on the display screen. This is described in more detail below. There may be many leaf nodes in the graphical hierarchical tree 130. Each leaf node may be displayed with a unique color to uniquely identify each resulting data cluster.

The decision nodes are the segments created after splitting the root segment (the input dataset) and that lead to other decision segments or leaf nodes. There may be additional decision segments 155 along the path, which divide the sub-sets of data based on specified decision boundaries, ultimately leading to a leaf segment. A decision segment may also split into additional decision segments until the path reaches a final cluster of a leaf node.

In one embodiment, decision segments/nodes may be displayed with a different color or other visual distinction from the leaf nodes. For example, decision segments may be displayed as white nodes while the leaf nodes may be displayed with a different color. Thus, the decision segments are easily identifiable from leaf nodes.

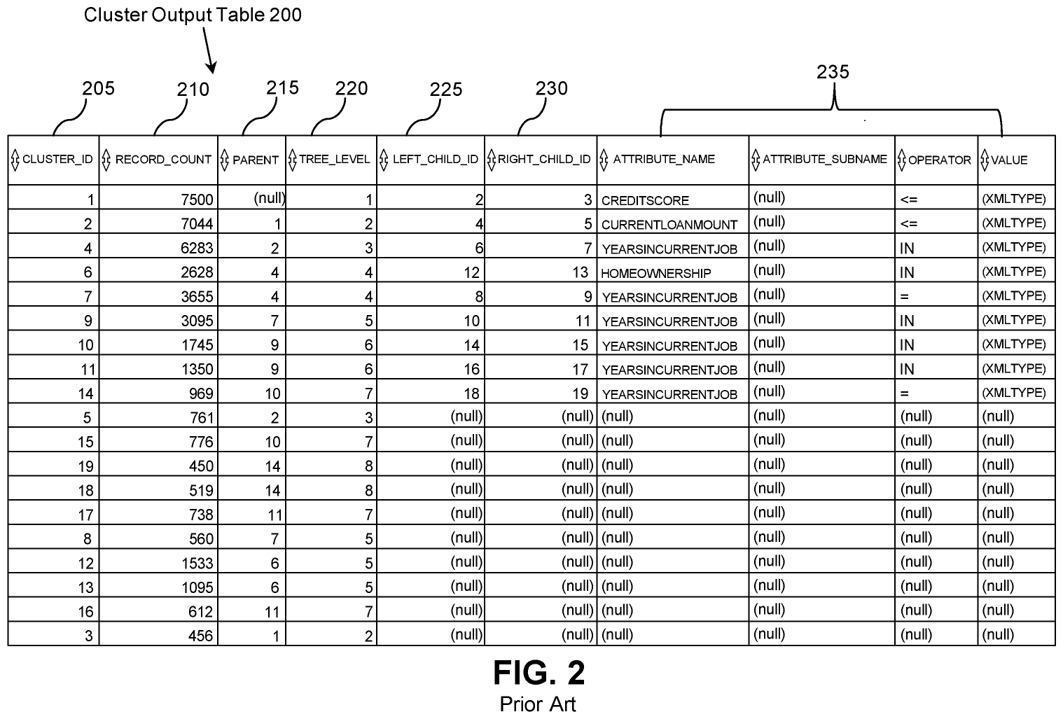

In one embodiment, the visualization system 100 converts the static cluster output table 120 into the graphical hierarchical tree 130 by recursively traversing the data in the cluster output table 120. The recursive algorithm analyzes the cluster output table 120 to identify a root cluster, identify child clusters from the root cluster and child clusters from each other that define parent-child relationships, and identify decision segments that caused a segment split of cluster data at a parent cluster. Additional examples are discussed with reference to FIGS. 2-4.

With continued reference to FIG. 1, in one embodiment, the 2-dimensional visual hierarchy is generated and displayed using the plurality of nodes and the path lines in a horizontal form on the display screen. The 2-dimensional visual hierarchy represents the parent-child relationships between each of the plurality of clusters and the decision segments from the cluster output table 120 using the plurality of nodes in a left-to-right structure. Tree levels are shown by nodes being displayed at the same position in the hierarchy. For example, tree level 1 includes the root node 135; tree level 2 includes leaf node 140 and decision node/segment 155; tree level 3 includes leaf node 145 and leaf node 150, etc. In another embodiment, the 2-D visual hierarchy may be displayed in a top-to-bottom structure that is vertically displayed on the display screen.

Decision nodes/segments 155 represent a decision condition based on one or more attribute values that caused the clustering algorithm 110 to split/divide the input dataset into the sub-sets of data represented by the child nodes of a decision node/segment 155. The decision node/segment 155 includes and displays its decision conditions (IF-ELSE condition) and values of attributes, which are decision boundaries, that form the decision condition. In the clustering algorithm, the decision conditions/boundaries identify how the input dataset is split into its child nodes (into data sub-sets).

For example, in FIG. 1, decision segment 155 splits an input dataset from the root node 135 into two sub-sets that are leaf segment 145 and leaf segment 150. The graphical hierarchical tree 130 may include many decision segments 155 along multiple paths, which are determined from cluster output table 120, and may include multiple decision segments 155 in succession until the path ends in a leaf node. The path lines between the plurality of nodes show a visual hierarchy between the plurality of clusters and segmenting decisions determined from the cluster output table 120, which starts at the top level root node 135.

As will be described below, a solid path line represents a link between two features in the dataset and represents a parent-child relationship. A different visual path line may be highlighted, such as a dashed line, that represents a highlighted link between two features with active indication. Active indication occurs in response to a selection made on a node in the graphical tree 130. The nodes in the graphical tree 130 are configured as selectable objects (e.g, by mouse click, touch, etc.) that a user can select.

In one embodiment, when a user selects a node, the visualization system 100 determines all nodes linked to the selected node in the hierarchy and visually highlights the path lines connecting the nodes. For example, if leaf segment 145 is selected, the visualization system 100 highlights the path links from all parent nodes back to the root node. In FIG. 1, the highlighted path links (e.g., the dashed lines) are from the root node 135 to decision segment 155 and to the selected leaf segment 145. The visualization system 100 may back track up the graphical tree 130 using the parent-child relationships and determine all parent nodes and path links to the root node 135.

With the highlighted path displayed, a user can easily visualize and discover the relevant features and decision boundaries that were considered by the clustering algorithm when the algorithm created the cluster data associated with the selected node/segment. The highlighted path also shows and emphasizes the order in which these decisions boundaries were considered and how each segment was split along the way. By following the highlighted path lines from the root node 135 to the selected node, or vice versa, the user can easily identify the decision segments (and their boundaries) that occurred leading to the selected node. Of course, following any path along the graphical tree 130 shows the order of decision segments that occur to split/segment the data and how the data is split leading to each final cluster of a leaf node segment. Thus, the graphical tree 130 provides information about how a particular cluster of data was created in an improved technique over the static cluster output table 120 and over other previous techniques such as scatter plot.

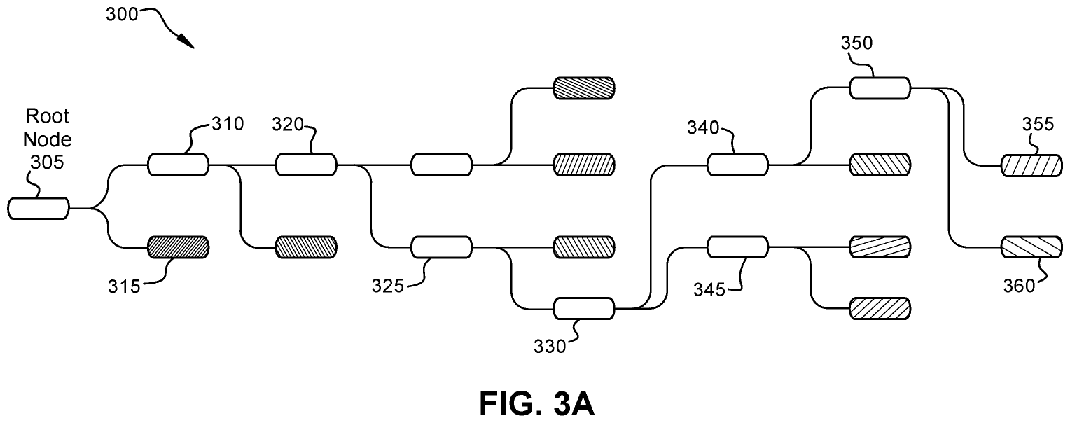

For example, while viewing the graphical tree 130, a user can very easily determine the decisions taken at each node that divided the data into multiple clusters/segments. The data cluster represented by leaf node segment 145 is determined by the decision segment 155 and its decision boundaries, which split the dataset in a certain way, as well as the data split that occurred at the root node 135. Such a determination is not readily apparent (and sometimes not determinable) for any particular cluster when viewing the numeric data directly from cluster output table 120 or from a scatter plot. The difficulty of understanding the cluster output table 120 is especially evident when there are multiple features/dimensions to the data and thus many rows of information in the table. An example of a cluster output table 120 is described with reference to FIG. 2 and resulting graphical tree with reference to FIG. 3A and FIG. 3B.

With reference to FIG. 2, a prior art example of a cluster output table 200 is shown, which is an example of the cluster output table 120 from FIG. 1. The cluster output table 200 may be a table that is generated by a clustering algorithm after the clustering algorithm builds clustering models from an input dataset. The clustering algorithm may be a machine learning algorithm that identifies patterns in an input dataset and creates clusters/segments of data based on the patterns. Different clustering algorithms are configured in different ways to handle an input dataset and find clusters/segments. When a clustering algorithm builds a clustering model on the input dataset, an output table is generated like the cluster output table 200 but may have different formats.

The output tables of these clustering algorithms are primarily in a numeric format of cluster results and are a data table configured in rows and columns of data. The numeric format is very difficult for an end-user to understand and difficult to identify relationships between clusters and how decisions were made by the clustering algorithm to split or segment the dataset.

For example, a clustering algorithm segments unsupervised training data in distinct clusters. Each cluster has unique properties and boundaries which distinguish the cluster from other clusters. Since clustering has been a black box that is inaccessible to end-users, it is challenging to understand how the workflow and pattern identification functions in the clustering algorithm consider input attributes and features of the input dataset.

### Example Use Case of Clustering

Giving credit is one source of income for the bank, but it also involves risk. To minimize the risk, the bank pays close attention to a client's history and how sure it is that the client can repay their debt. For this to happen, in the past, the bank always relied on statistical methods. Nowadays, these decisions can be managed by machine learning models, and their forecasts about future repayments provide more accurate predictions.

In such a use case, it becomes imperative to find patterns in the data. The banker may wish to know the characteristics of the customer population, the behavior of a particular customer, and a relationship between the customers behavior with the behavior of the general public. Segmenting the customers into various groups allows this to happen. Using segmentation on a bank's credit default data helps the banker understand different types of groups in the customer population. Suppose the customer data has financial and personal details of some customers. Some customer features may include their education, occupation, income bracket, credit score, number of years in the current job, etc. The clustering algorithms can segment the customers (customer records) based on these features. One segment/cluster might include highly-paid customers with bigger tax brackets. Another segment/cluster might have the customers who have a lower credit score.

This intuitive information helps an end-user to make better judgments. The present visualization system 100 provides advantages and improvements to this process including plotting decision boundaries that separate various clusters into a 2-dimensional graphical tree. As explained earlier, various clustering algorithms provide clustering results as certain output tables after it builds clustering models. The following example (cluster output table 200) is a description table generated when a clustering model was built on a credit default dataset having the above-mentioned features.

With reference to FIG. 2, the cluster output table 200 is an example output of cluster data from a clustering algorithm. The cluster output table 200 will be used to describe how the present visualization system 100 operates but is not limited to the particular structure of the cluster output table 200.

In general, the cluster output table 200 table contains description information about the clustering results, for example but not limited to, cluster segments, the features used to decide a data split, their feature importance, cluster hierarchies (parent-child clusters), cluster distributions, etc. The table 200 may provide description information about parent segments and its children segments. Along with identifying the parent-children segments, it tells the user on what basis the split of the parent happened. This table has a lot of important information to explain the decision flow of the clustering algorithm but is not easy to comprehend and so cannot be readily consumed by the end-user.

For example, the cluster output table 200 may include various columns of data, where each row is associated with information about a particular cluster ID. The columns may include, for example, a column for a cluster ID 205 that identifies a particular cluster of data, and a record count 210 showing the number of data records that belong in the associated cluster ID. Each cluster/segment has a unique cluster ID to identify the cluster/segment. A parent cluster ID 215 identifies a parent cluster from which the current cluster ID was split from. A tree level column 220 identifies a hierarchy level of where the current cluster is found. A left child cluster ID 225 and a right child cluster ID 230 identify child clusters (if any) that were split/divided out from the current cluster. Knowing the structure of the cluster output table 200, the present visualization system 100 is configured to identify the columns and its corresponding data as described below.

Additional columns may describe decision boundaries 235 that are the basis for splitting the cluster data into the left child and right child clusters. The decision boundaries 235 may include columns for attributes used (attribute name) in the decision, attribute subname (if any), an operator used in the decision and values that define decision segments/boundaries.

Thus, looking at the table 200, every row has information on one cluster, represented by the column “CLUSTER_ID” 205. In the next column “RECORD COUNT” 210, identifies the number of records (e.g., number of customers) belonging to this cluster. The next few columns 215, 220, 225, and 230 describe the relationships among the parent and children clusters. For every cluster, these columns give the ID of the children clusters. The remaining columns (decision boundaries 235) describe the decision the clustering algorithm/model took internally to divide the parent cluster into the left/right children clusters. The final column “Value” has values in XML format of the decision boundary, which are not displayed in the example.

For example, by looking at the first row for Cluster ID #1, it can be deduced that customer records in cluster 1 were divided into two clusters (cluster ID #2 and cluster ID #3) based on their credit scores (Attribute Name). By looking at the XML variable value (e.g., example value=4047.5), one can determine that if the credit score of the customer was less than or equal to 4047.5 (based on the Operator “<=”), they belong to cluster ID #2 (Left Child ID) otherwise they belong to cluster ID #3 (Right Child ID). Looking at row 2, cluster ID #2 is further split into a left child cluster ID #4 and a right child cluster ID #5 based on a decision boundary 235 involving the value of their “Current Loan Amount” (Attribute Name).

Moving down the table to the row for cluster ID #5, it is seen that there are “Null” values (no value) for the columns for left child 225 and right child 230. This means that cluster ID #5 was not further divided/segmented. Thus, cluster ID #5 defines a particular cluster of records that ends at tree level 3 shown in Tree Level column 220.

In general, based on the configuration and format of the cluster output table 200 that is used an input dataset to the visualization system 100, the system is configured to identify particular information about clusters from the table 200. For example, the visualization system 100 is configured analyze, parse, and/or query the cluster output table 200 to identify one or more columns (or combination of columns) of clustering information that may be available from the structure of the cluster output table 200. From this information, the visualization system 100 is configured to generate a graphical hierarchical tree that converts the cluster output table 200 into a 2-dimensional visual hierarchy using a plurality of nodes and path lines. An example of the graphical hierarchical tree that may be generated from the cluster results of the cluster output table 200 is shown in FIG. 3A and FIG. 3B.

With reference to FIG. 3A, one embodiment of a graphical hierarchical tree 300 that may be generated from the cluster results of the cluster output table 200 is shown. FIG. 3B illustrates one embodiment of the graphical hierarchical tree 300 from FIG. 3A shown in an expanded/zoomed view with more node details but shown as being wrapped/folded in order to fit on one page or one viewable display screen. The trees in FIG. 3A and FIG. 3B have the same nodes and tree structure.

The white/clear tree nodes represent decision segments, which include nine (9) decision segments including the root node. The grey/hatched tree nodes represent leaf nodes, which include ten (10) leaf nodes. In one embodiment, the leaf nodes are visually distinguished from the decision segments/nodes. In one embodiment, the tree nodes are generated as scalable vector graphics (SVG) and are configured to be selectable objects in a graphical user interface on a display screen.

In one embodiment, the graphical hierarchical tree 300 is a horizontal decision model that includes a tree node for each cluster (segment of data) found from the cluster output table 200 based on the cluster ID. In one embodiment, each decision segment/node includes, and displays adjacent to itself, a decision boundary to show how the data was divided at that point. This may include displaying the “attribute,” the “operator,” and “value” that is used in its decision boundary.

The graphical tree 300 starts with a root node 305, which represents Cluster ID #1 that contains the entire input dataset of 7500 records. This is determined from row 1 in the cluster output table 200, which represents the data for Cluster ID #1. The root node 305 is a decision segment since the dataset is split at this point into two segments/clusters: child node 310 and child node 315. Child node 310 is determined from row 1 and the “Left Child” cluster ID column (which represents Cluster ID #2) and child node 315 is determined from row 1 and the “Right Child” cluster ID column (which represents Cluster ID #3).

The root node 305 shows that its decision boundary is based on “Credit Score<=4047.5.” This is identified from cluster ID #1 (row 1) in the cluster output table 200 in FIG. 2. Based on this decision boundary, the 7500 records of the input dataset are split into child node 310, which is Cluster ID #2 and contains 7044 records that have a credit score <= to the value set in the root node. Child node 315 represents Cluster ID #3 and contains the remaining 456 records that have a credit score greater than the value set in the root node 305.

As visually determined from the graphical hierarchical tree 300, child node 315 is a decision segment that continues to segment the data records. The child node 320 is a leaf node and thus is a final cluster result that contains 456 records of customers with credit scores greater than 4047.5.

Continuing down the hierarchy of the graphical hierarchical tree 300, which is left-to-right from the root node 305, multiple decision segments and leaf nodes are seen. For example, it can be easily determined from the visual hierarchy that the input dataset is segmented into particular clusters based on a successive order of decision boundaries involving a number of years that a customer has been at their current job. This is shown by decision nodes/segments 320, 325, 330, 335, 340, 345 and 350 based on “Years In Current Job” attribute.

Following their connected path lines, these decision segments lead to final clusters of records represented by leaf node 355 and leaf node 360. Leaf node 355 represents “Cluster ID #18” with 519 records. Leaf node 330 represents “Cluster ID #19” with 450 records. This cluster information corresponds to the rows in the cluster output table 200 (FIG. 2) corresponding to Cluster ID #18 and Cluster ID #19 in the Cluster ID column 205.

Thus, following any path along the graphical tree 300 visually shows the order of decision segments that split the data, how the data is split, and what final clusters were created. In this manner, the present graphical tree 300 conveys insights into the decisions made by the clustering algorithm. This is a significant improvement over previous techniques such as heat maps or scatter plots that attempt to describe clustering results but do not provide any insights into the decisions made by the clustering algorithm.

In one embodiment, the graphical hierarchical trees generated by the present visualization system 100 may be used to easily and visually identify errors in decision boundaries or incorrect decisions made by a clustering algorithm/model, which were previously very difficult to identify. This includes displaying decision boundaries associated with each decision segment. Appropriate actions may then be performed to retrain or rebuild the clustering algorithm/model and/or update the input dataset. Thus, the clustering results may be adjusted in a desired manner.

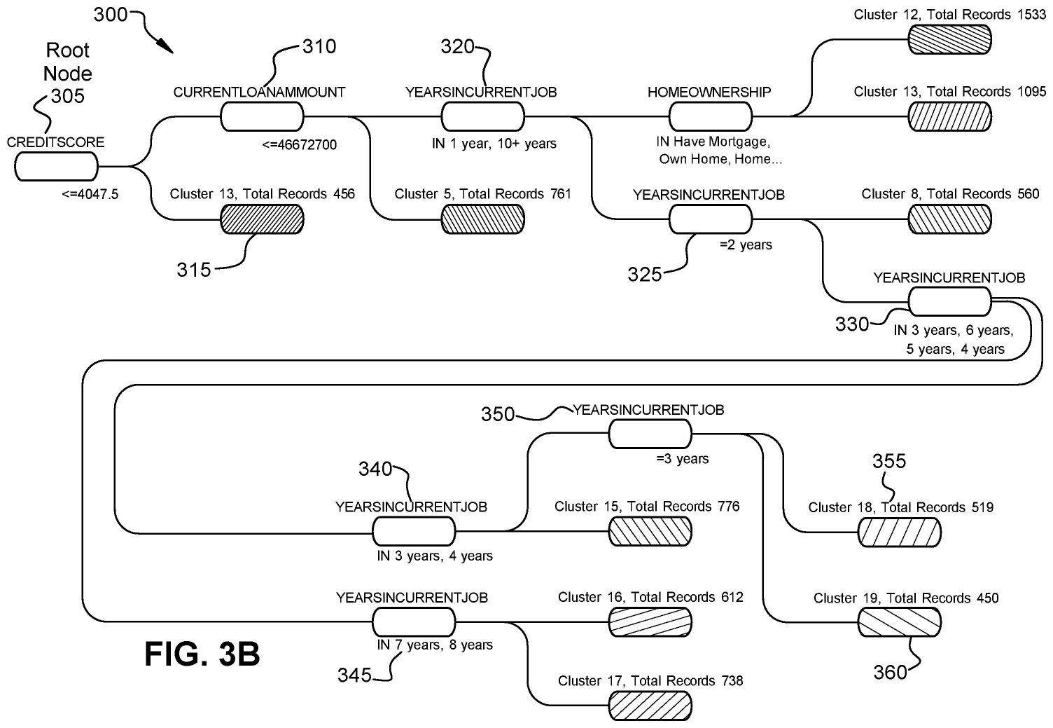

In one embodiment, the present visualization system 100 is configured to analyze and recognize the data from the cluster output table 200 using a recursive algorithm as described with reference to FIG. 4.

With reference to FIG. 4, one embodiment of a recursive algorithm 400 is shown that is associated with recognizing and identifying a root cluster (to become a root node) and successively identifying child clusters (to become child nodes). The recursive algorithm 400 is programmatically implemented as executable code.

The recursive algorithm 400 is configured to determine the root node for the visualization from a cluster output table that is inputted. To achieve this, the cluster output table is sorted at block 405 based on tree level and the first segment in the sorted data is assigned as the root segment (block 410). “Create_network(node)” function is initiated, which starts at block 415.

By using the root node/segment, the algorithm 400 verifies whether a left and/or right node/segment (e.g., child clusters) are present (blocks 420 and 425) from the row data associated with the root cluster. The algorithm 400 also extracts from the row data any decision condition and values from the decision boundary columns (see columns 235 in FIG. 2).

When the left and right segments exist (“Yes” at decision blocks: child cluster/segment exists), the cluster IDs of the child clusters are assigned to the corresponding left node or right node that is created (blocks 430 and 435) and a path link between parent and child nodes are created (block 440). The path links and nodes corresponding to the child clusters/segments are stored (block 445).

Upon successful creation of left and right segments, these segments are fed back to block 415 for the next step. This process is recursively executed and repeated until a leaf node is found (at block 450) when there are no left child or right child node/clusters for a cluster ID in its data row). The recursive process ends when no additional child nodes are found for a node/cluster and thus the current node/cluster is a leaf node. This is performed until all leaf nodes are found in the cluster output table, which is the point when no other leaf nodes exist.

On completion of the recursive model, a graphical object is generated dynamically for each node and link as a path line between two parent-child nodes. Each node may have a shape, for example, a rectangle, an oval, a circle, or other desired shape. The graphical object may be a scalable vector graphics (SVG) element and configured to be a selectable object on a display screen. Each node also contains the cluster information of the node, for example, cluster ID, segment decision boundaries/condition, segment value, segment number, segment name, start node, and/or end node.

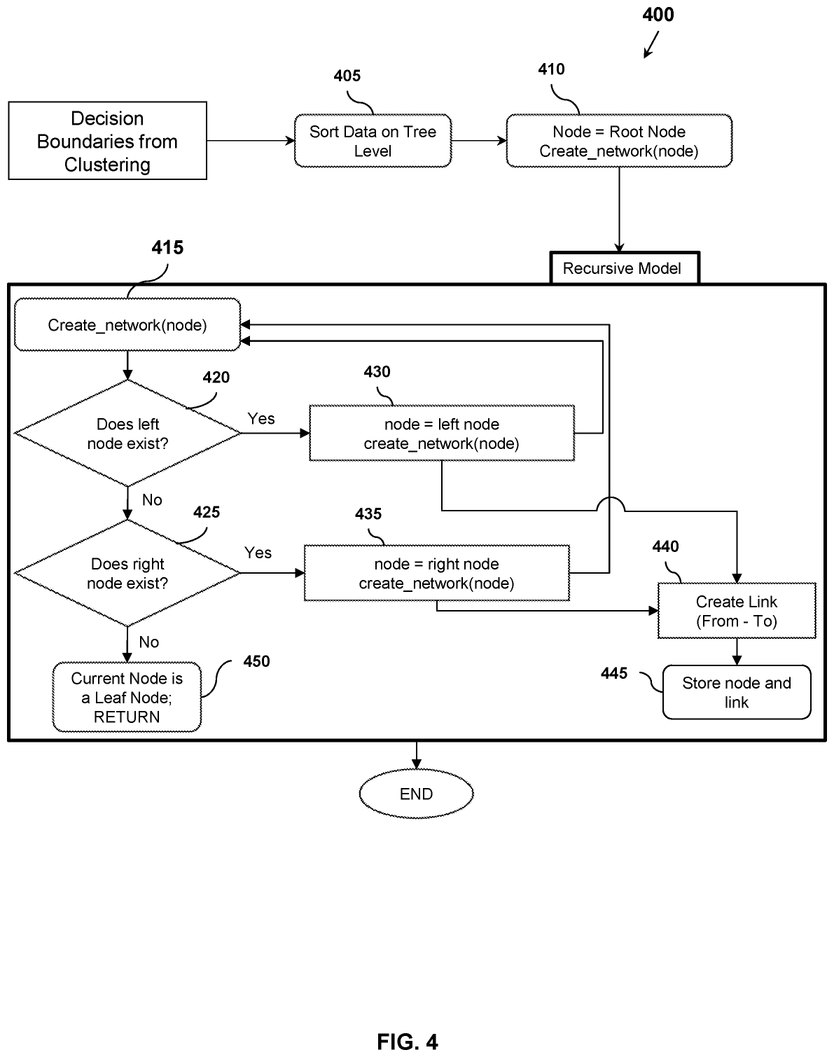

With reference to FIG. 5, one embodiment of method 500 is illustrated that is associated with converting a static cluster output table into a graphical hierarchical tree. The visualization system 100 is configured as an executable algorithm that is executed by at least a computing device and a processor to perform the method 500 and is based on previously described functions. The cluster output table, for example, may be similar to the cluster output table 200 shown in FIG. 2. As previously described, the cluster output table is generated by a clustering algorithm or model that creates clusters for data from an input dataset. The cluster output table is input to the visualization system 100 and/or is accessed by the visualization system 100 by knowing the stored network location of the cluster table.

At block 510, the cluster output table is analyzed. As previously described, the cluster output table comprises a numeric format of cluster results that identify a plurality of clusters/segments from the input dataset and identifies whether a cluster includes child clusters that resulted from a segment split caused by a decision segment. The column names in the cluster output table may be identified by querying the table.

At block 520, a root cluster is identified from the plurality of clusters. In one embodiment, this may include sorting the rows from the cluster output table based on a cluster identifier (ID) from lowest value to greatest value. The root cluster will be in a row of data that has a cluster ID value or “1” or an equivalent value that should be the lowest cluster ID value from the cluster ID column. From this row of data, child clusters are found along with decision boundaries as previously described.

At block 530, the cluster output table is recursively traversed from the root cluster to: (i) identify the child clusters from each parent cluster that creates a parent-child relationship; (ii) identify the decision segments that caused the segment split of cluster data at the parent cluster; and (iii) determine the parent-child relationship between the plurality of clusters. In one embodiment, the recursive algorithm 400 of FIG. 4 is applied.

At block 540, the algorithm assigns the root cluster as a root node and propagates the child clusters as child nodes to define a hierarchy of nodes based on the parent-child relationships to each other. In one embodiment, this is described in the algorithm 400 of FIG. 4 where left child nodes, right child nodes, and path links are created and stored.

At block 550, a graphical hierarchical tree is generated that converts the cluster output table into a 2-dimensional visual hierarchy using the stored nodes that start with the root node and displays the child nodes connected with the path lines based on the parent-child relationships. In one embodiment, the generated tree may have a structure similar to the graphical hierarchical tree 300 of FIG. 3A, 3B previously described. The graphical hierarchical tree 300 is generated and displayed in a graphical user interface on a display screen of a computing device. The graphical user interface provides features for a user to interact with graphical hierarchical tree 300 such as being able to select tree nodes.

As seen in the graphical hierarchical tree 300 of FIG. 3A or 3B, each node in the 2-dimensional visual hierarchy represents either (i) a final cluster from the cluster output table 200 that is displayed as a leaf node, or (ii) a decision segment, displayed as a decision node, containing a cluster of records that is further segmented/split. Thus, the path lines between the nodes show a visual hierarchy between all the clusters from the cluster output table and their relationships to each other.

In one embodiment, the 2-dimensional visual hierarchy of the generated tree is generated and displayed in a horizontal form on a display screen as seen in FIGS. 1 and/or 3A/3B, which provides for an easy to understand visual representation of the cluster output table. Furthermore, the 2-dimensional visual hierarchy represents the parent-child relationships of the clusters using the plurality of nodes in a horizontal left-to-right structure.

In one embodiment, the decision segments in the graphical hierarchical tree are generated with at least two child nodes. The two child nodes represent (i) two leaf node clusters, (ii) two other decision segments, or (iii) one leaf node cluster and one other decision segment. Examples are seen in the graphical tree 130 (FIG. 1) and the graphical tree 300 (FIG. 3A and/or 3B). As previously explained, decision segments cause a segment split of the cluster data that leads to at least two child nodes.

### Segment/Node Selection Embodiment

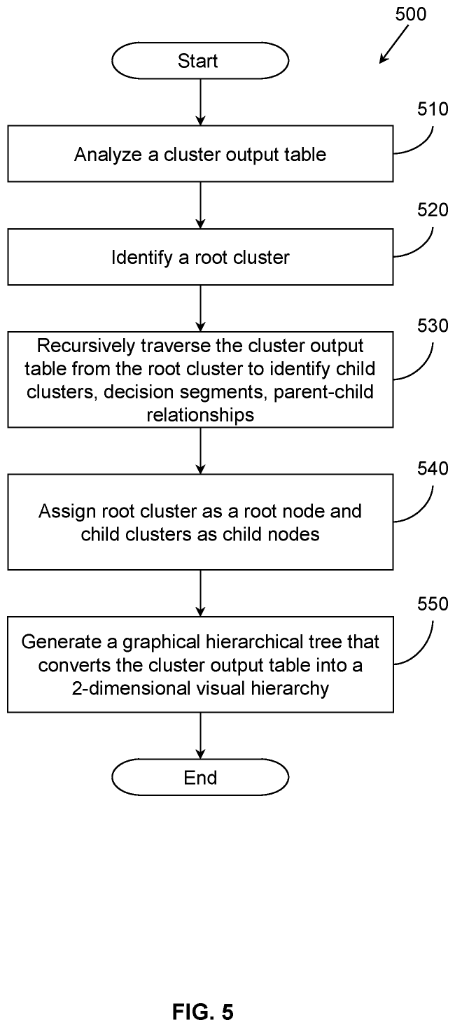

With reference to FIG. 6, the graphical hierarchical tree 300 (from FIG. 3B) is shown with interactive selection features, in one embodiment. These selection features generate a hierarchy path overview and the path leading to a selected leaf node is highlighted through all parent nodes in the tree.

With the interactive selection features, the visualization system 100 and the generated graphical hierarchical tree 300 are configured to help users mine data and discover insights from the cluster output table that was not previously readily apparent.

As previously mentioned, each of the plurality of tree nodes may be configured as selectable objects in the 2-dimensional visual hierarchy of the graphical hierarchical tree 300. The graphical object may be a scalable vector graphics (SVG) element and configured to be a selectable object on a user interface. The selection of a tree node triggers the visualization system 100 to display the hierarchy (the parent-child relationships) associated with the selected tree node. This allows a user to easily determine visually how the clustering algorithm determined the data cluster contained in the selected tree node and what decision segments were involved.

For example, in FIG. 6, leaf node 360 is shown as being selected by a user (shown with bolded dash outline). In response to the leaf node 360 being selected from the 2-dimensional visual hierarchy, the visualization system 100 highlights the path lines (e.g., dashed-lines) from the root node 305 that lead to the selected leaf node 360 including all parent nodes of the selected leaf node 360. Thus, the parent-child relationships are displayed by the highlighted path lines.

With the present features, the highlighted path lines visually identify the parent-child relationships between the nodes in the hierarchy that belong to the selected leaf node 360. This allows a user to easily visually determine all the decision segments that were involved and used by the clustering algorithm to arrive at the clustered data represented by the selected leaf node 360. For example, there are seven (7) decision segments/nodes including the root node 305 leading to the selected tree node 330. These seven decision segments divided the initial dataset to produce the final clustered data in leaf node 360, which contains “Cluster #19” with “450” Total Records in the cluster.

Furthermore, from the decision segments along the highlighted path lines, the user can easily determine the decision boundaries that were considered by the clustering algorithm to split the data at any particular decision node. At each decision node, the node displays its associated decision boundaries that split the data. For example, in FIG. 6, at decision node 340, which is along the highlighted path, it shows the attribute “Years in Current Job” is involved in the decision with the decision operator and values as “IN 3 years, 4 years.”

In one embodiment, the highlighted path lines may be displayed as dashed-lines or other type of highlighting that visually distinguishes the highlighted path lines and/or their nodes from the other solid path lines and nodes that are not parent nodes of the selected tree node 360.

With the present graphical tree 300, advantages and improvements over previous techniques are provided. For example, by viewing the hierarchical order of the decision segments that lead to a leaf node (a final cluster), a domain expert can discover whether some of the features used in the decision segments are incorrect or should not be considered in the way they are being considered in the decision segment. Or they may discover that some important features are left out of the consideration if they are missing from the graphical tree. By identifying such issues from the graphical tree, the domain expert can rebuild or retrain the clustering algorithm with updated data to obtain a desired final cluster representation.

### Parent Node Selection

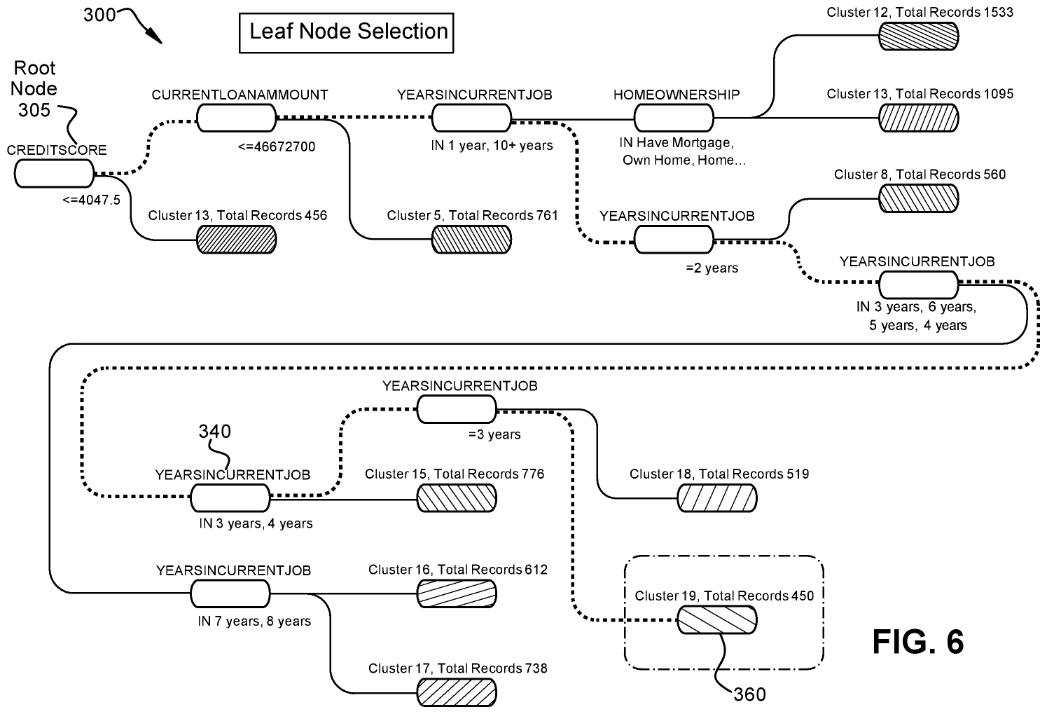

With reference to FIG. 7, another selectable feature may include selecting a parent node. In general, a parent node is a node that includes child nodes. Thus, a parent node is any node that is not a leaf node, which does not have child nodes. FIG. 7 illustrates the same graphical hierarchical tree 300 (from FIGS. 3B and 6) with parent node 340 emphasized with a bold dashed-line after it is selected by a user on the graphical user interface. Thus, the hierarchical tree 300 reveals all the leaf nodes that ultimately result and lie in its path by highlighting the paths and nodes that pass through them.

In response to the parent node 340 from the plurality of nodes being selected in the 2-dimensional visual hierarchy, the visualization system 100 determines and highlights the path lines that connect the selected parent node to all its child nodes leading to each leaf node in a hierarchy from the parent node 340. And, the highlighted path lines also identity all the decision segments from the root node 305 to the selected parent node 340 to illustrate what decision segments were involved and how decisions were made to segment the cluster results leading to the selected parent node 335. The highlighted path is shown as a dashed-line in FIG. 7.

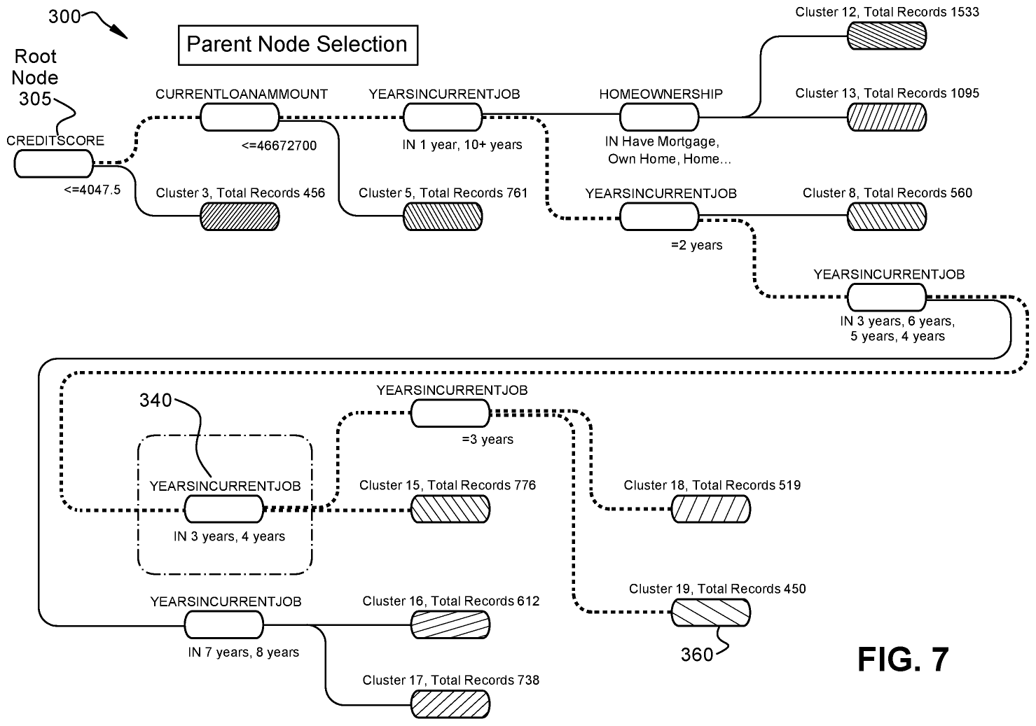

In another embodiment, with reference to FIG. 8, selecting or hovering a pointing device (e.g., mouse pointer) over a leaf node in the tree causes segment information about the node/segment to be displayed. For example, a pop-up window 800 may be generated and displayed adjacent to the leaf node. The pop-up window 800 reveals the cluster/segment information that is contained by the leaf node. The pop-up window 800 reveals that the leaf node represents Cluster ID 18 and the cluster includes 519 Total Records.

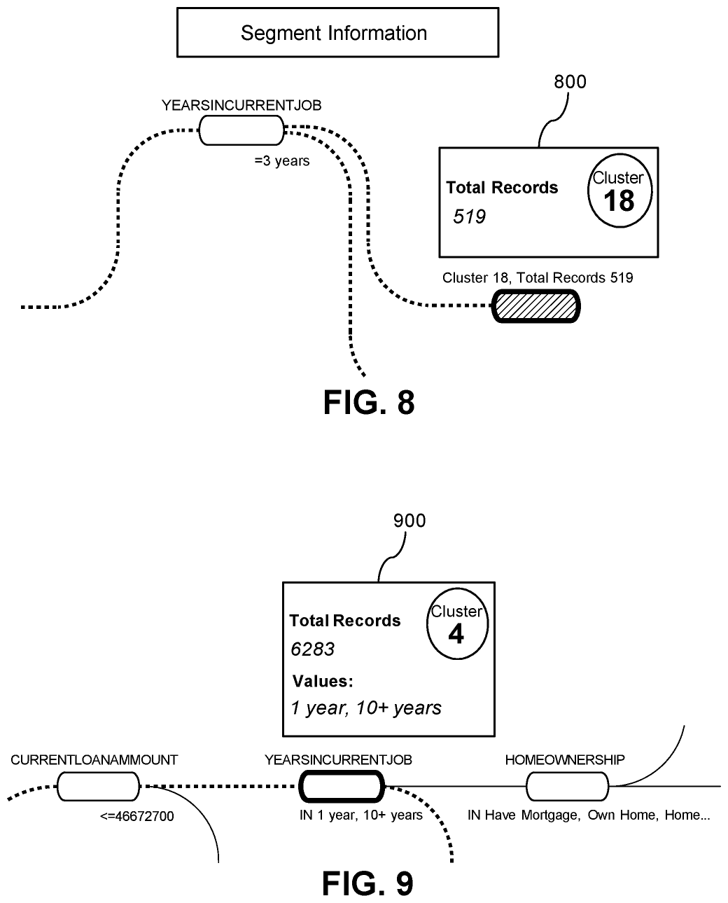

In a similar manner, with reference to FIG. 9, selecting or hovering a pointing device (e.g., mouse pointer) over a decision node/segment causes segment information about the decision node/segment to be displayed. For example, a pop-up window 900 may be generated and displayed adjacent to the decision node. The pop-up window 900 reveals the cluster/segment information that is contained by the decision node and the decision boundary values. For example, a segment hover shows details about its decision boundaries, including the total records, the decision condition, and the decision value, and/or the main characteristics of the segment features. The pop-up window 900 reveals that the decision segment represents Cluster ID 4 and the cluster includes 6283 Total Records. The decision boundaries for splitting the data records of Cluster ID 4 include the attribute “Years in Current Job” with Operator and Values “IN 1 year, 10+ years.”

### Process Flow for Path Highlighting on Node/Segment Selection

In one embodiment, the visualization system 100 is configured to determine the nodes and which path links to highlight in response to a node selection using a recursive model. For example, once a node/segment is selected by a user, the selected node's unique cluster ID is parsed and forwarded to the recursive model. The recursive model is configured to discover all the related links based on cluster IDs from the cluster output table, in one embodiment.

As inputs, the recursive model uses two parameters, one being the direction of search and the other being the cluster ID. The direction of the search is either “previous” or “next” from a current node in the hierarchical tree. “Previous” means searching towards a previous node (a parent node) in the hierarchy starting from the selected node, which is towards the root node. “Next” means searching towards the next node (child node) in the hierarchy.

By passing in the cluster ID with the search direction being set to “previous” or “next,” the recursive model looks for all possible links whose end node or start node matches with the passed cluster ID and saves all of the nodes.

Once all the links have been found, the recursive model runs the same recursive model again until no more links are found. The found path links are then highlighted with a dashed-line in the graphical tree for better visibility and differentiation from non-highlighted path links.

In another embodiment, each of the tree nodes is configured as a linked list with pointer values. The pointer values include a parent pointer to its parent node and child pointers to each child node, in any. The visualization system 100 may then determine the highlighted paths (based on a selected node) by traversing the parent and child pointers for each node that is connected to the selected node. The identified path links are then highlighted as previously described.

Overall, the present visualization system improves upon previous clustering description techniques. In low dimensional space (e.g., 1-3 dimensions/features), data segments may be visualized over a previous scatter plot technique to see how many data points are grouped in each segment. However, as the dimensional space increases (e.g., more than 3), data segments cannot be visualized in a scatter plot. Furthermore, the biggest disadvantage of the previous scatter plot approach is that an end-user cannot get an understanding of why and how data segments were grouped and what decision checks/decisions on the input features were taken into consideration by the clustering algorithm.

The present visualization system and technique is implemented on top of and converts static clustering tables (and cluster decision tables) produced by clustering algorithms. The graphical hierarchical tree generated by the present system describes the relevant features and decision boundaries that were considered while creating those segments and in which order these decisions were considered by the clustering algorithm. Having this characteristic allows the user to see how many decision checks were made by the clustering algorithm to obtain each final cluster/segment. All this information is highly useful in increasing the explainability and transparency of the clustering algorithm (or segmentation module) from the end user's perspective.

The present visualization system, in one embodiment, illustrates the role that features play in segment creation based on the displayed decision segments. It may guide domain experts in the feature selection and feature engineering phase for modeling a clustering algorithm. With the present graphical tree, by viewing the hierarchical order of decision segments, a domain expert can discover whether some of the features used are incorrect and should not be considered in the way they are being considered in the decisions. Or they may discover that some important features are left out of the consideration if they are missing from the graphical tree. They can accordingly update the data as per the acquired understanding, rebuild the clustering algorithm again and thus work iteratively towards the desired feature consideration and cluster representation.

As an example, in the credit default use case discussed herein, while viewing the graphical hierarchical tree, user may determine that the feature “year in current job tenure of 3 years” should not affect the final result cluster in a presented way. The domain expert can then take direct appropriate actions to adjust the clustering algorithm/model by modifying the data accordingly or dropping the feature altogether from the clustering algorithm. Without the present visualization, the number of combinations of steps needed to be performed to identify such an issue and make adjustments to the clustering algorithm would be enormous if using the traditional trial and error experimentation method. In general, the present visualization gives the expert flexibility and visibility to speed the process to adjust the clustering algorithm to acquire the desired segmentation results.

### Cloud or Enterprise Embodiments

In one embodiment, the visualization system 100 is a computing/data processing system including an application or collection of distributed applications for enterprise organizations. The applications and computing system 100 may be configured to operate with or be implemented as a cloud-based networking system, a software as a service (SaaS) architecture, or other type of networked computing solution. In one embodiment the visualization system is a centralized server-side application that provides at least the functions disclosed herein and that is accessed by many users via computing devices/terminals communicating with the computing system (functioning as the server) over a computer network.

In one embodiment, one or more of the components described herein are configured as program modules stored in a non-transitory computer readable medium. The program modules are configured with stored instructions that when executed by at least a processor cause the computing device to perform the corresponding function(s) as described herein.

### Computing Device Embodiment

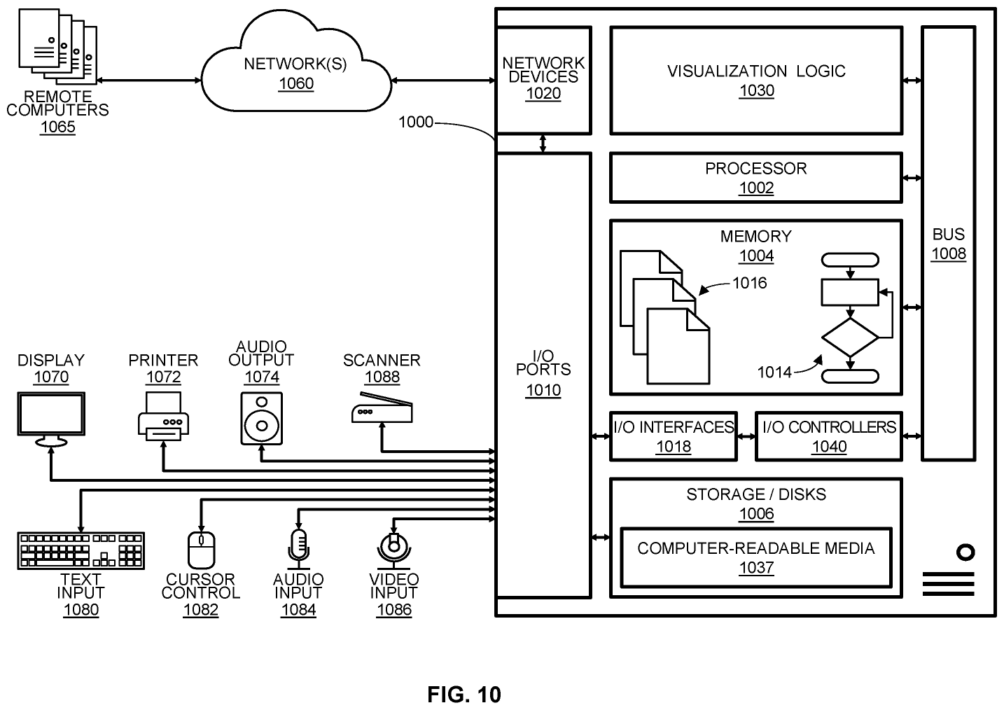

FIG. 10 illustrates an example computing device that is configured and/or programmed as a special purpose computing device with one or more of the example systems and methods described herein, and/or equivalents. The example computing device may be a computer 1000 that includes at least one hardware processor 1002, a memory 1004, and input/output ports 1010 operably connected by a bus 1008. In one example, the computer 1000 may include visualization logic 1030 configured to facilitate converting a static cluster data table comprising cluster results of a dataset to a graphical hierarchical tree similar to the visualization system 100 shown in FIGS. 1-9.

In different examples, the logic 1030 may be implemented in hardware, a non-transitory computer-readable medium 1037 with stored instructions, firmware, and/or combinations thereof. While the logic 1030 is illustrated as a hardware component attached to the bus 1008, it is to be appreciated that in other embodiments, the logic 1030 could be implemented in the processor 1002, stored in memory 1004, or stored in disk 1006.

In one embodiment, logic 1030 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to convert a static cluster data table comprising cluster results of a dataset to a graphical hierarchical tree. The means may also be implemented as stored computer executable instructions that are presented to computer 1000 as data 1016 that are temporarily stored in memory 1004 and then executed by processor 1002.

Logic 1030 may also provide means (e.g., hardware, non-transitory computer-readable medium that stores executable instructions, firmware) for performing a conversion of a static cluster data table comprising cluster results of a dataset to a graphical hierarchical tree.

Generally describing an example configuration of the computer 1000, the processor 1002 may be a variety of various processors including dual microprocessor and other multi-processor architectures. Memory 1004 may nclude volatile memory and/or non-volatile memory. Non-volatile memory may include, for example, ROM, PROM, and so on. Volatile memory may include, for example, RAM, SRAM, DRAM, and so on.

A storage disk 1006 may be operably connected to the computer 1000 via, for example, an input/output (I/O) interface (e.g., card, device) 1018 and an input/output port 1010 that are controlled by at least an input/output (I/O) controller 1040. The disk 1006 may be, for example, a magnetic disk drive, a solid state disk drive, a floppy disk drive, a tape drive, a Zip drive, a flash memory card, a memory stick, and so on. Furthermore, the disk 1006 may be a CD-ROM drive, a CD-R drive, a CD-RW drive, a DVD ROM, and so on. The memory 1004 can store a process 1014 and/or a data 1016, for example. The disk 1006 and/or the memory 1004 can store an operating system that controls and allocates resources of the computer 1000.

The computer 1000 may interact with, control, and/or be controlled by input/output (I/O) devices via the input/output (I/O) controller 1040, the I/O interfaces 1018, and the input/output ports 1010. Input/output devices may include, for example, one or more displays 1070, printers 1072 (such as inkjet, laser, or 3D printers), audio output devices 1074 (such as speakers or headphones), text input devices 1080 (such as keyboards), cursor control devices 1082 for pointing and selection inputs (such as mice, trackballs, touch screens, joysticks, pointing sticks, electronic styluses, electronic pen tablets), audio input devices 1084 (such as microphones or external audio players), video input devices 1086 (such as video and still cameras, or external video players), image scanners 1088, video cards (not shown), disks 1006, network devices 1020, and so on. The input/output ports 1010 may include, for example, serial ports, parallel ports, and USB ports.

The computer 1000 can operate in a network environment and thus may be connected to the network devices 1020 via the I/O interfaces 1018, and/or the I/O ports 1010. Through the network devices 1020, the computer 1000 may interact with a network 1060. Through the network, the computer 1000 may be logically connected to remote computers 1065. Networks with which the computer 1000 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A non-transitory computer-readable medium that includes stored thereon computer-executable instructions that when executed by at least a processor of a computer cause the computer to:
analyze, by at least the processor, a cluster output table that was generated by a clustering algorithm from a dataset;
wherein the cluster output table comprises a numeric format of cluster results that identify a plurality of clusters from the dataset and identify whether a cluster includes child clusters that resulted from a segment split caused by a decision segment;
identify a root cluster from the plurality of clusters;
recursively traverse the cluster output table from the root cluster to:
(i) identify the child clusters from each parent cluster that creates a parent-child relationship;
(ii) identify the decision segments that caused the segment split of cluster data at the parent cluster; and
(iii) determine the parent-child relationship between the plurality of clusters;
assign the root cluster as a root node and propagate the child clusters as child nodes based on the parent-child relationship to each other;
generate a graphical hierarchical tree that converts the cluster output table into a 2-dimensional visual hierarchy using a plurality of nodes that starts with the root node and displays the child nodes connected with path lines based on the parent-child relationships;
wherein the path lines between the plurality of nodes show a visual hierarchy between the plurality of clusters from the cluster output table; and
wherein each node in the 2-dimensional visual hierarchy represents either
(i) a final cluster from the cluster output table that is a leaf node, or
(ii) a decision segment that caused the segment split of cluster data.

2. The non-transitory computer-readable medium of claim 1, wherein the instructions to generate the graphical hierarchical tree further comprise instructions that when executed by at least the processor cause the processor to:
generate and display the 2-dimensional visual hierarchy using the plurality of nodes and the path lines in a horizontal form on a display screen;
wherein the 2-dimensional visual hierarchy represents the parent-child relationships of the plurality of clusters using the plurality of nodes in a left-to-right structure.

3. The non-transitory computer-readable medium of claim 1,
wherein the numeric format of the cluster results of the cluster output table is a table configured in rows and columns;
wherein the instructions are configured to cause the processor to:
identify the columns including a column for at least a cluster ID, a parent cluster ID, a left child cluster ID, a right child cluster ID, and values that define decision segments; and
generate the graphical hierarchical tree that converts the cluster output table into the 2-dimensional visual hierarchy based at least on data from the columns identified.

4. The non-transitory computer-readable medium of claim 1, further comprising instructions that when executed by at least the processor cause the processor to:
generate the decision segments in the graphical hierarchical tree that cause the segment split of the cluster data that leads to at least two child nodes by generating the at least two child nodes to represent (i) two leaf clusters, (ii) two other decision segments, or (iii) one leaf cluster and one other decision segment.

5. The non-transitory computer-readable medium of claim 1, further comprising instructions that when executed by at least the processor cause the processor to:
configure each of the plurality of nodes as selectable objects in the 2-dimensional visual hierarchy; and
in response to a parent node from the plurality of nodes being selected in the 2-dimensional visual hierarchy, highlighting the path lines that connect the parent node to child nodes leading to each leaf node in a hierarchy from the parent node;
wherein the highlighted path lines also identity all the decision segments from the root node to the parent node to illustrate how decisions were made to segment the cluster results.

6. The non-transitory computer-readable medium of claim 1, further comprising instructions that when executed by at least the processor cause the processor to:
configure each of the plurality of nodes as selectable objects in the 2-dimensional visual hierarchy; and
in response to a leaf node being selected from the plurality of nodes in the 2-dimensional visual hierarchy, highlighting the path lines from the root node that lead to the leaf node including all parent nodes of the leaf node.

7. The non-transitory computer-readable medium of claim 1, wherein the instructions when executed by at least the processor cause the processor to:
generate the 2-dimensional visual hierarchy that displays an order that decision segments were performed by the clustering algorithm to split the dataset that resulted in a final cluster of a leaf node.

8. A computing system, comprising:
at least one processor connected to at least one memory;
a display device operably connected to the at least one processor;
a non-transitory computer readable medium including instructions stored thereon that when executed by at least the processor cause the processor to:
receive a static cluster data table as input, wherein the static cluster data table comprises cluster results of a dataset that were generated by a clustering algorithm;
convert the static cluster data table into a graphical hierarchical tree by:
recursively traversing the static cluster data table to identify a root cluster, identify child clusters from the root cluster and child clusters from each other that define parent-child relationships, and identify decision segments that caused a segment split of cluster data at a parent cluster;
generating and displaying, on the display screen, a 2-dimensional visual hierarchy in graphical form using a plurality of nodes that represent the root cluster and the child clusters; and
generating and displaying, on the display screen, path lines that connect the plurality of nodes based on the parent-child relationships;
wherein the 2-dimensional visual hierarchy displays a hierarchical visualization of the static cluster data table that shows an order of decision segments that occurred to segment the dataset and how the dataset was segmented by the clustering algorithm leading to a final cluster of a leaf node.

9. The computing system of claim 8, wherein the instructions to generate and display the 2-dimensional visual hierarchy in graphical form further include instructions that when executed by at least the processor cause the processor to:
generate and display the 2-dimensional visual hierarchy using the plurality of nodes and the path lines in a horizontal form on the display screen;
wherein the 2-dimensional visual hierarchy represents the parent-child relationships of the plurality of clusters using the plurality of nodes in a left-to-right structure.

10. The computing system of claim 8,
wherein the static cluster data table includes a numeric format of the cluster results of the static cluster output table is a table format configured in rows and columns;
wherein the instructions are configured to cause the processor to:
identify the columns including a column for at least a cluster ID, a parent cluster ID, a left child cluster ID, a right child cluster ID, and values that define decision segments; and
generate the graphical hierarchical tree that converts the static cluster data table into the 2-dimensional visual hierarchy based at least on data from the columns identified.

11. The computing system of claim 8 is further configured to:
generate the decision segments as nodes in the graphical hierarchical tree that cause the segment split of the cluster data that leads to at least two child nodes by generating the at least two child nodes to represent (i) two leaf clusters, (ii) two other decision segments, or (iii) one leaf cluster and one other decision segment.

12. The computing system of claim 8, wherein the instructions further include instructions that when executed by at least the processor cause the processor to:
configure each of the plurality of nodes as selectable objects in the 2-dimensional visual hierarchy; and
in response to a parent node being selected from the plurality of nodes in the 2-dimensional visual hierarchy, highlight the path lines that connect the parent node to child nodes leading to each leaf node in a hierarchy from the parent node;
wherein the highlighted path lines also identity all the decision segments from the root node to the parent node to illustrate how decisions were made to segment the cluster results.

13. The computing system of claim 8, wherein the instructions further include instructions that when executed by at least the processor cause the processor to:
configure each of the plurality of nodes as selectable objects in the 2-dimensional visual hierarchy; and
in response to a leaf node being selected from the plurality of nodes in the 2-dimensional visual hierarchy, highlight the path lines from the root node that lead to the leaf node including all parent nodes of the leaf node.

14. The computing system of claim 8, wherein the instructions further include instructions that when executed by at least the processor cause the processor to:
generate the 2-dimensional visual hierarchy including displaying decision boundaries associated with each of the decision segments to visually identify errors in the decision boundaries made by the clustering algorithm.

15. A computer-implemented method, the method comprising:
converting a static cluster data table comprising cluster results of a dataset to a graphical hierarchical tree, wherein the cluster results were generated by a clustering algorithm, the converting comprising:
recursively traversing the static cluster data table to identify a root cluster, identify child clusters from the root cluster and child clusters from each other that define parent-child relationships, and identify decision segments that caused a segment split of cluster data at a parent cluster; and
generating and displaying, on a display screen, a 2-dimensional visual hierarchy in graphical form using a plurality of nodes that represent the root cluster and the child clusters; and
generating and displaying, on the display screen, path lines that connect the plurality of nodes based on the parent-child relationships;
wherein the 2-dimensional visual hierarchy displays a hierarchical visualization of the static cluster data table that shows an order of decision segments that occurred to segment the dataset and how the dataset was segmented by the clustering algorithm leading to a final cluster of a leaf node.

16. The method of claim 15, wherein generating and displaying the 2-dimensional visual hierarchy in graphical form further comprises:
generating and displaying the 2-dimensional visual hierarchy using the plurality of nodes and the path lines in a horizontal form on the display screen;
wherein the 2-dimensional visual hierarchy represents the parent-child relationships of the plurality of clusters using the plurality of nodes in a left-to-right structure.

17. The method of claim 15,
wherein the static cluster data table includes a numeric format of the cluster results of the static cluster output table is a table format configured in rows and columns;
wherein the method further comprises:
identifying the columns including a column for at least a cluster ID, a parent cluster ID, a left child cluster ID, a right child cluster ID, and values that define decision segments; and
generating the graphical hierarchical tree that converts the static cluster data table into the 2-dimensional visual hierarchy based at least on data from the columns identified.

18. The method of claim 15, further comprising:
generating the decision segments in the graphical hierarchical tree that cause the segment split of the cluster data that leads to at least two child nodes by generating the at least two child nodes to represent (i) two leaf clusters, (ii) two other decision segments, or (iii) one leaf cluster and one other decision segment.

19. The method of claim 15, further comprising:
configuring each of the plurality of nodes as selectable objects in the 2-dimensional visual hierarchy; and
in response to a parent node being selected from the plurality of nodes in the 2-dimensional visual hierarchy, highlighting the path lines that connect the parent node to child nodes leading to each leaf node in a hierarchy from the parent node;
wherein the highlighted path lines also identity all the decision segments from the root node to the parent node to illustrate how decisions were made to segment the cluster results.

20. The method of claim 15, further comprising:
configuring each of the plurality of nodes as selectable objects in the 2-dimensional visual hierarchy; and
in response to a leaf node being selected from the plurality of nodes in the 2-dimensional visual hierarchy, highlighting the path lines from the root node that lead to the leaf node including all parent nodes of the leaf node.
